(19) United States
(12) Patent Application Publication
(10) Pub. No.: US 2026/0180621 A1
(43) Pub. Date: Jun. 25, 2026

(54) DELAY-TUNABLE DATA TRANSMISSION IN A MULTIPHASE POWER CONVERTER

(71) Applicant: Texas Instruments Incorporated, Dallas, TX (US)

(72) Inventors: Preetam Tadeparthy, Jakkur (IN); Abhishek Sardeshpande, Bangalore (IN); Vaibhav Jagadish, Bangalore (IN); Vishal Shaw, Salkia (IN); Vikas Lakhanpal, Bangalore (IN)

(21) Appl. No.: 19/195,023

(22) Filed: Apr. 30, 2025

(30) Foreign Application Priority Data
Dec. 24, 2024 (IN) 202441102366

(51) Int. Cl. H04B 3/54; H04L 7/06; H04L 25/49

(52) U.S. Cl. CPC H04B 3/542; H04L 7/06; H04L 25/4902

(57) ABSTRACT

A secondary controller for a multiphase power converter includes a delay control circuit configured to adjust the timing of sending data back to a primary controller to account for signal propagation latency between the secondary controller and the primary controller. A synchronizer within the delay control circuit uses a second clock signal to sample a first clock signal sent by the primary controller. The second clock signal may then be used by an edge detection circuit configured to determine a time duration between a falling edge and a subsequent rising edge of the sampled version of the first clock signal. The time duration may be reduced using an offset to generate a shorter time duration using an offset trigger circuit. Following a countdown of the shorter time duration reaching zero, a trigger signal may be sent to a data transmission circuit configured to transmit data back to the primary controller.

### CROSS-REFERENCE TO RELATED APPLICATION

This application claims priority to Indian Provisional Patent Application No. 202441102366 filed on Dec. 24, 2024, which is incorporated herein by reference in its entirety.

### TECHNICAL FIELD

This description relates to voltage control using power converters, and more particularly, to multiphase power converters.

### BACKGROUND

Power converters are widely used in electronic systems such as consumer electronics, automotive systems, industrial equipment, lighting systems, data centers etc. for converting an input voltage to an output voltage higher or lower than the input voltage. Such converters utilize a power switch that turns on and off to regulate the output voltage. A feedback loop along with a controller is also used to determine the on or off time of the power switch in each switching cycle based on the feedback voltage representative of the power converter output voltage, and a reference voltage, thereby regulating the output voltage of the power converter. A multiphase power converter may be used in applications that require relatively high current loads (e.g., hundreds of amps). There remain challenges in providing optimal control of the multiple phases in the multiphase power converter.

### SUMMARY

According to an example, an electronic device includes a synchronizer configured to receive a first clock signal and generate a second clock signal responsive to the first clock signal and a third clock signal, an edge detection circuit configured to determine a rising edge of the second clock signal and a falling edge of the second clock signal, an offset trigger circuit, and a data transmission circuit. The edge detection circuit also stores a first time duration between the rising edge and the falling edge based on a number of pulses from the third clock signal between the rising edge and the falling edge. The offset trigger circuit is designed to subtract an offset from the first time duration to yield a second time duration smaller than the first time duration, count a number of pulses from the third clock signal within the second time duration, and in response to reaching an end of the count, output a trigger signal. The data transmission circuit receives the trigger signal and outputs data in response to receiving the trigger signal.

According to another example, a system includes a first controller designed to generate a first clock signal, a plurality of second controllers each designed to receive the first clock signal from the first controller and to transmit a data signal to the first controller, and a plurality of power converter stages. Each of the power converter stages corresponds to a second controller of the plurality of second controllers and is configured to receive a pulse width modulated (PWM) signal from the corresponding second controller. At least one of the second controllers includes a synchronizer designed to receive the first clock signal and to generate a second clock signal responsive to the first clock signal and a third clock signal, an edge detection circuit designed to use the third clock signal to determine a rising edge of the second clock signal and a falling edge of the second clock signal, an offset trigger circuit, and a data transmission circuit. The edge detection circuit also stores a first time duration between the rising edge and the falling edge of the second clock signal. The offset trigger circuit is designed to reduce the first time duration based on an offset to yield a second time duration, count a number of pulses from the third clock signal within the second time duration, and in response to reaching an end of the count, output a trigger signal. The data transmission circuit receives the trigger signal and transmits the data signal in response to receiving the trigger signal.

According to another example, a system includes a processor, a first controller configured to generate a clock signal, a second controller configured to receive the clock signal from the first controller and to transmit a first data signal to the first controller through a first conductive trace having a first trace length, a third controller configured to receive the clock signal from the first controller and to transmit a second data signal to the first controller through a second conductive trace having a second trace length different from the first trace length, a first plurality of power stages coupled to the second controller and designed to provide a first output voltage to at least a portion of the processor, and a second plurality of power stages coupled to the third controller and designed to provide a second output voltage to at least a portion of the processor. The second controller transmits the first data signal at a first time corresponding to a first offset from a first time duration associated with a time between a first rising edge and a first falling edge of the clock signal. The third controller transmits the second data signal at a second time corresponding to a second offset from a second time duration associated with a time between a second rising edge and a second falling edge of the clock signal with the second offset being different from the first offset.

### BRIEF DESCRIPTION OF THE DRAWINGS

FIG. 1 is a diagram of a data center having any number of server devices with at least one power-controlled central processing unit (CPU), in an example.

FIG. 2 is a block diagram illustrating a multiphase power converter system for delivering a controlled output power to a load, in an example.

FIGS. 3A and 3B illustrate data and clock timing waveforms between primary and secondary controllers of the multiphase power converter system, in an example.

FIG. 4 is a schematic diagram showing a multiphase power converter system, in an example.

FIG. 5 is a block diagram showing a delay control circuit of the multiphase power converter system, in an example.

FIG. 6 is a schematic diagram showing a synchronizer of the delay control circuit, in an example.

FIG. 7 is a schematic diagram showing linked storage elements that may be used as part of the synchronizer, in an example.

FIG. 8 is a schematic diagram showing an edge detection circuit of the delay control circuit, in an example.

FIG. 9 is a schematic diagram showing an offset trigger circuit of the delay control circuit, in an example.

FIG. 10 is a schematic diagram showing a data transmission circuit of the delay control circuit, in an example.

FIG. 11 is a timing diagram comparing how data transmitted to the primary controller can be shifted in time to avoid data corruption, in an example.

FIG. 12 is a flowchart of a method for shifting the timing of transmitting data from a secondary controller to the primary controller to account for signal propagation latency between the secondary and primary controller, in an example.

FIG. 13 is a schematic diagram of a controller coupled to a single power converter stage, in an example.

### DETAILED DESCRIPTION

Techniques are described for delay-tunable data transmission in a multiphase power converter including a primary controller and one or more secondary controllers. In an example, a secondary controller for a multiphase power converter includes a delay control circuit configured to adjust the timing of sending data back to a primary controller to account for signal propagation latency between the secondary controller and the primary controller. A synchronizer within the delay control circuit may receive a first clock signal from the primary controller and use a second clock signal to oversample the first clock signal thus generating a third clock signal. The use of the terms ‘first,’ ‘second,’ and ‘third’ may be interchangeable—for example, the delay control circuit may also receive a first clock signal from the primary controller and generate a second signal by oversampling the first clock signal using a third clock signal. The second clock signal may also be used by an edge detection circuit configured to determine a time duration between a falling edge and a subsequent rising edge of the third clock signal. The time duration may correspond to a number of second clock cycles between the falling edge and subsequent rising edge of the third clock signal. The time duration may be reduced using an offset to generate a shorter time duration using an offset trigger circuit. Following a countdown of the shorter time duration reaching zero, a trigger signal may be sent to a data transmission circuit configured to transmit data back to the primary controller. The shorter time duration may be used to effectively transmit the data early (e.g., before receiving a rising edge of the first clock signal) to account for a timing delay due to signal propagation between the secondary controller and the primary controller. For example, the time duration between rising and falling edges of the third clock signal may be stored in separate buffers and adjusted to generate a reduced time duration used to cause the data to transmit earlier than if the data had been transmitted on the rising or falling edge of the third clock signal. Since the third clock signal (generated by the synchronizer) is used to determine the reduced time duration, any change in the frequency of the first clock signal received from the primary controller or any presence of clock jitter does not impact the delay control circuit's ability to account for timing delay. The delay control circuit described herein may also be agnostic to voltage regulation protocols, which make the circuit adaptable across a wide range of server platforms. Numerous other variations will be apparent based on the examples described herein.

### General Overview

As described above, multiphase power converters are used in many applications to supply on-demand and relatively stable voltage and current to a load. Briefly, such power converters generate an output current, which passes through one or more inductors to provide a direct current (DC) load current to a load. The output current represents the sum of all currents provided from each of the power converter stages in the power converter. When the current demand suddenly rises at the load, the multiphase power converter keeps up with the new demand by firing off additional power converter stages, with each power converter stage capable of supplying a given maximum current. A controller is used to dictate when and how many of a given number of available power converter stages are to supply load current. Several such controllers may each be coupled to any number of power converter stages, each such controller being a secondary controller. Additionally, a primary controller may provide timing and data instructions to each of the secondary controllers that control the power converter stages. The secondary controllers may also each transmit data back to the primary controller.

Due to the greater number of secondary controllers compared to the primary controller, signal latency between the controllers may not always be equal. The signal latency is affected by the total length of the conductive trace on the board or chip between the controllers. For example, a first secondary controller that is physically located closer (e.g., having a shorter trace length) to the primary controller on a printed circuit board (PCB) or in a chip package may be able to send and receive signals faster compared to a second secondary controller that is physically located farther (e.g., having a longer trace length) from the primary controller. Due to space constraints, it may not be possible to arrange all secondary controllers to have the same trace length between them and the primary controller. The inconsistent latency between controllers can lead to timing errors and data corruption.

Thus, in accordance with some examples of the present disclosure, a delay control circuit for use within a multiphase power converter is described. The delay control circuit may be used within each of the secondary controllers (e.g., the controllers that control the firing of the power converter stages) to compensate for signal latency between the given secondary controller and a primary controller. A primary clock signal is generated by the primary controller and received by each of the secondary controllers to dictate the timing of the various operations performed by the secondary controllers. According to some examples, one of those operations includes data transfer back to the primary controller. Based on the signal latency between a given secondary controller and the primary controller, the timing of sending the data back to the primary controller can be adjusted using the delay control circuit configured to ensure that the data is not received too late by the primary controller, according to some examples.

According to some examples, the delay control circuit includes a synchronizer that is designed to sample or oversample the primary clock signal received from the primary controller at a sampling frequency higher than the frequency of the primary clock signal. An edge detection circuit may then be used to determine the rising and falling edges of the sampled version of the primary clock signal, and a time duration between the rising and falling edges is also determined. The time duration may be equal to or at least proportional to a number of sampling frequency cycles between the rising and falling edges of the primary clock signal (or the sampled version of the primary clock signal). The time duration may then be decreased based on an offset value to create a shortened time duration. The offset value may be different for each secondary controller based on its distance (e.g., trace length) from the primary controller. Secondary controllers closer to the primary controller may have a smaller offset value while secondary controllers further from the primary controller may have a larger offset value. In any case, when the time comes to transmit data back to the primary controller, rather than transmitting the data based on the period of the primary clock signal, the shortened time duration is used instead to effectively transmit the data earlier than it would have been if based on the timing of the primary clock signal, according to some examples. The earlier transmission of the data compensates for the signal latency between the secondary controller and the primary controller to avoid mis-capturing the data at the primary controller. According to some embodiments, the delay control circuit provides additional degrees of freedom by allowing a user or the system to tune the delay at the system level using a stored offset value and the synchronizer with a latched comparator to generate an oversampled version of the primary clock signal. Furthermore, the design complexity of the delay control circuit is reduced compared to other delay tuning circuits, which provides greater flexibility in what platforms the delay control circuit can be used with. Numerous other variations will be apparent based on the examples described herein.

### Example Computing Environment

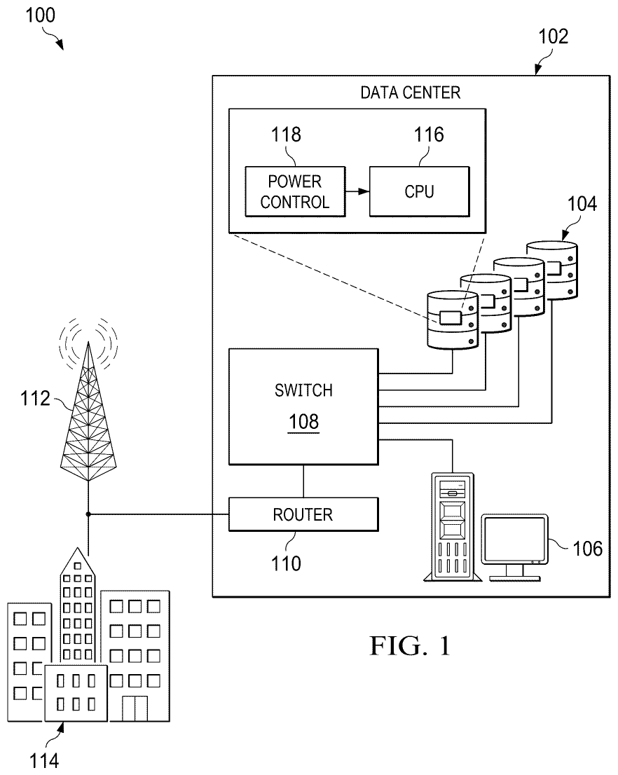

FIG. 1 illustrates an example data infrastructure 100 having a data center 102 with any number of servers 104. Data center 102 may also include a computer 106 to control the operations of servers 104 and provide a user interface to monitor and/or controller the operations of servers 104 and any other electronic equipment within data center 102. In some examples, communication between servers 104 and the outside world are facilitated by a switch 108 and router 110 configuration. Other components of data center 102 may include power subsystems, uninterruptible power supplies (UPS), ventilation systems, cooling systems, fire suppression systems, and backup generators. Signals either entering or leaving data center 102 via router 110 may be received/sent through one or more towers 112 for wireless cellular-based communication or may be received/sent through hardwired connections to any number of buildings 114.

According to some examples, each server 104 includes at least one central processing unit (CPU) 116 along with a power control circuit 118. Power control circuit 118 may include or otherwise represent a multiphase DC-DC power converter to provide the load current requested by CPU 116. In some examples, the power demands of CPU 116 fluctuate depending on the operational demands of CPU 116, and power control circuit 118 must quickly be able to provide the requested power, which can reach as high as several amperes.

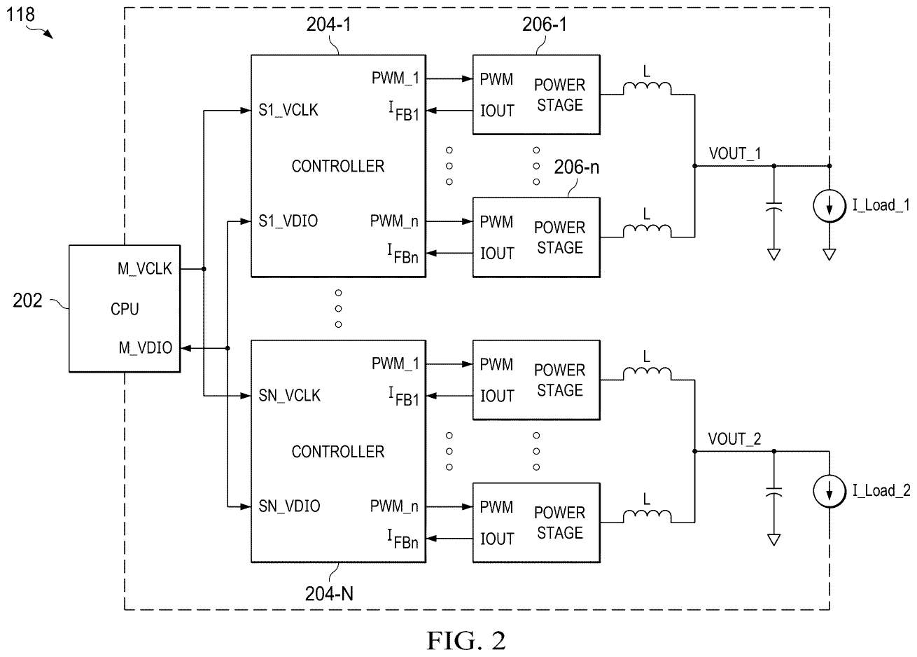

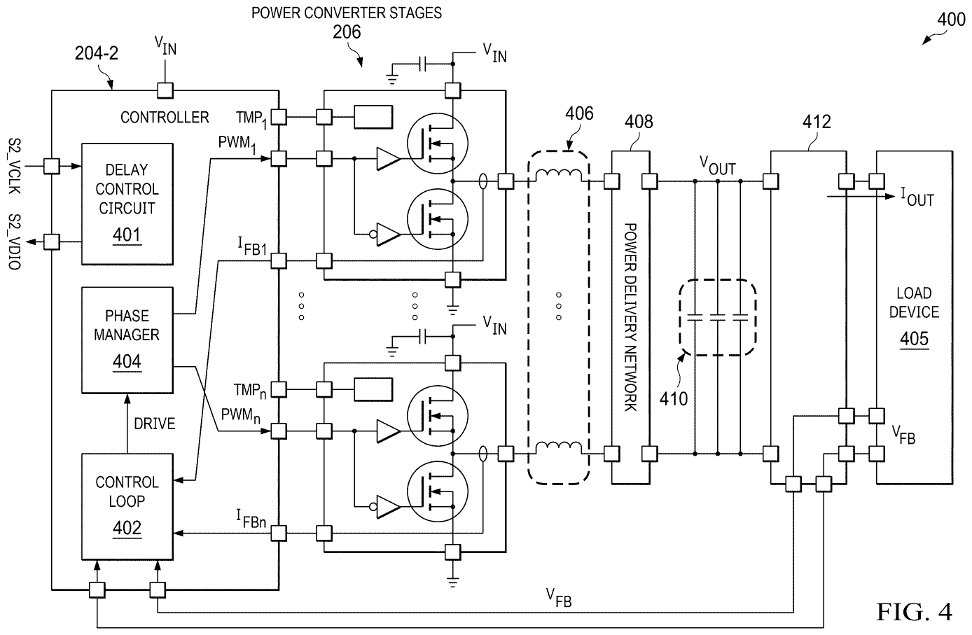

FIG. 2 illustrates at least a portion of power control circuit 118 that includes a primary controller 202 and any number of secondary controllers 204-1-204-N (collectively referred to as secondary controllers 204), according to some examples. Primary controller 202 may be a part of CPU 116, or may be separate from CPU 116. According to some examples, each secondary controller 204 is coupled to a corresponding set of power converter stages 206-1-206-n (collectively referred to as power converter stages 206). Accordingly, each secondary controller 204 controls the operations of a multiphase DC-DC power converter to deliver load current I_Load. Further details about the arrangement of each multiphase DC-DC power converter are provided with reference to FIG. 4.

As noted above, load current I_Load may be delivered to CPU 116, based on its power demands. In some examples, each multiphase DC-DC power converter delivers load current to the same CPU. In other examples, each multiphase DC-DC power converter delivers load current to different CPUs or different electrical components. In other examples, each multiphase DC-DC power converter delivers load current to different portions of the same CPU (e.g., different cores of the CPU).

According to some examples, primary controller 202 delivers a primary clock signal M_VCLK that is received by secondary controllers 204 at the S1_VCLK-SN_VCLK terminals. M_VCLK may be used to control the timing operations of secondary controllers 204, such as when to activate the corresponding power converter stages 206 and when to send data back to primary controller 202. Data may be transmitted as a data signal across data line traces connected between the primary data terminal M_VDIO at primary controller 202 and secondary data terminals S1-VDIO-SN_VDIO. In some examples, primary controller 202 may send data across the data line traces to select which of secondary controllers 204 is active at any given time. According to some examples, each secondary controller 204 may transmit a data signal back across a given data line trace to primary controller 202. This transmitted data signal may include any number of bits to indicate whether an action requested by primary controller 202 was accepted or not. In some examples, the transmitted data signal includes any number of bits to convey diagnostic data regarding the secondary controller 204 (e.g., voltage, current, power, temperature, etc.)

The time it takes to transmit the data signal from each secondary controller 204 to primary controller 202 may not be consistent based on the length of the data line traces between the controllers. For example, a first secondary controller 204-1 may have a first data line trace length to primary controller 202 while a second secondary controller 204-2 (or any other of the N controllers 204) may have a second data line trace length to primary controller 202 that is longer than the first data line trace length. In such an example, it will take longer to transmit the data signal between second secondary controller 204-2 and primary controller 202 compared to the time it takes to transmit the data signal between first secondary controller 204-1 and primary controller 202. This can cause issues such as protocol timing violations if the data signal is received too late at primary controller 202.

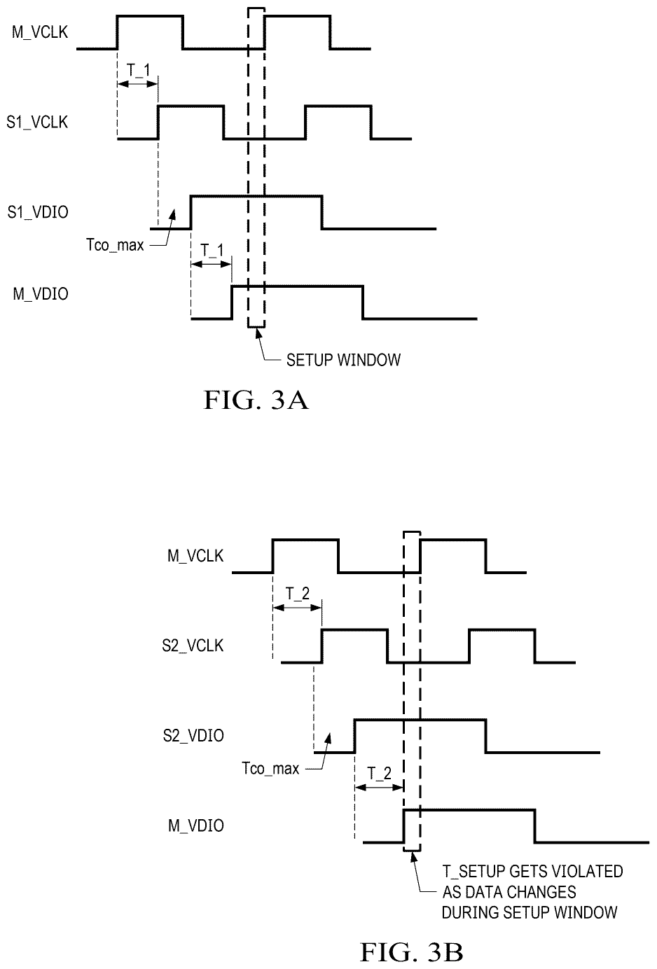

FIGS. 3A and 3B illustrate an example of the situation described above, with FIG. 3A providing a timing diagram of data transfer between first secondary controller 204-1 and primary controller 202, and FIG. 3B providing a timing diagram of data transfer between second secondary controller 204-2 and primary controller 202. Starting with FIG. 3A, a primary clock signal is transmitted at the M_VCLK terminal and received at the S1_VCLK terminal of first secondary controller 204-1 following a first signal propagation delay T_1, that is based on a first trace length between primary controller 202 and first secondary controller 204-1. Upon receiving the primary clock signal, first secondary controller 204-1 transmits out a data signal at the S1_VDIO terminal following an internal delay Tco_max, which may be generally the same for each secondary controller and based on its internal architecture. Following another first signal propagation delay T_1, the data signal is received at the M_VDIO terminal of primary controller 202. Note that the data signal is received at primary controller 202 prior to a setup window, which precedes the next rising edge of the primary clock signal. Data corruption and/or timing errors can occur if the data signal is not received prior to the start of the setup window.

Turning to FIG. 3B, a primary clock signal is transmitted at the M_VCLK terminal and received at the S2_VCLK terminal of second secondary controller 204-2 following a second signal propagation delay T_2, that is based on a second trace length between primary controller 202 and second secondary controller 204-2. In this example, second secondary controller 204-2 has a longer second trace length between itself and primary controller 202 compared to the first trace length, which causes second signal propagation delay T_2 to be greater than first signal propagation delay T_1. Upon receiving the primary clock signal, second secondary controller 204-2 transmits out a data signal at the S2_VDIO terminal following an internal delay Tco_max, which may be generally the same for each secondary controller and based on its internal architecture. Following another second signal propagation delay T_2, the data signal is received at the M_VDIO terminal of primary controller 202. Due to the longer delays, the setup window at primary controller 202 begins before it has received the data signal from second secondary controller 204-2. As a result, the data may become corrupted and/or protocol timing violations occur.

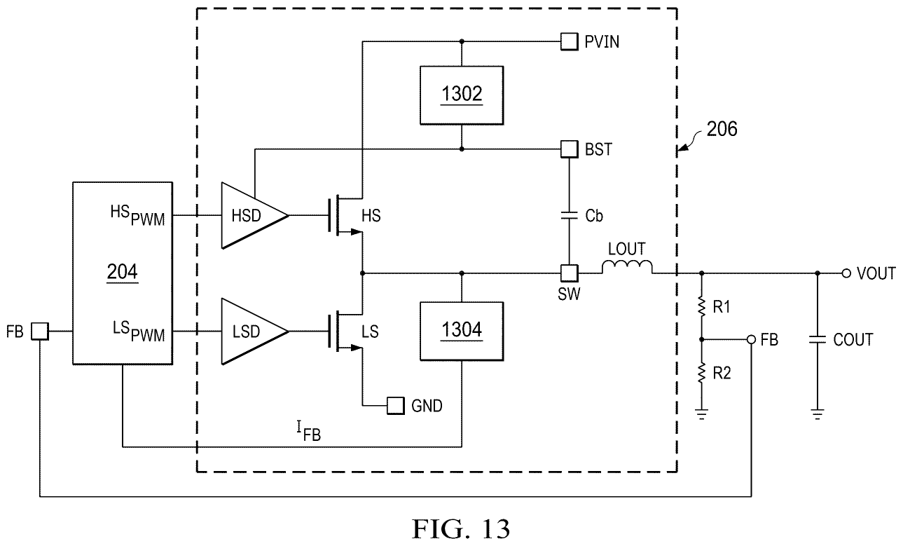

According to some examples, the timing of transmitting the data signal from each secondary controller 204 may be adjusted using a delay control circuit. FIG. 4 illustrates at least a portion of an electronic system 400 that includes a multiphase power converter with secondary controller 204-2 having its own delay control circuit 401 to control when to send data signal out of terminal S2_VDIO in order to account for the signal propagation delay across the data line trace, according to some examples. Other examples may be configured differently. It should be understood that any of the N secondary controllers 204 (as illustrated in FIG. 2) may be arranged to have their own delay control circuit 401 and be configured to control the activation of power converter stages 206, as shown in FIG. 4. Accordingly, the description herein regarding controller 204-2 may apply equally to any of secondary controllers 204-1-204-N illustrated in FIG. 2. Secondary controller 204-2 and power converter stages 206 may be implemented as a system-on-chip, or as a chip set populated on a PCB, or as a set of discrete components populated on a PCB, which may in turn be populated into a chassis of a multi-chassis system or an otherwise higher-level system, although any number of implementations can be used. Further details of each power converter stage 206 are provided with reference to FIG. 13, in accordance with some examples. Secondary controller 204-2 may receive an input voltage (V_{IN}) from a system bus or any voltage source within, for example, a computing environment. In some examples, secondary controller 204-2 is coupled to other computing components, such as a board management controller (BMC) to facilitate communication across a network.

According to some examples, secondary controller 204-2 includes at least a control loop 402 and a phase manager 404, which are used to control the timing of pulse width modulated output signals (PWM) that are used to drive up to N different power converter stages 206. Briefly, control loop 402 receives various feedback signals in the form of current feedback I_{FB} (via terminals I_{FB1}, . . . , I_{Fn}) from one or more of power converter stages 206 and voltage feedback V_{FB} (e.g., via V_{FB} terminals) from the load device 405 to produce output signals such as a drive signal. In some examples, the voltage feedback V_{FB} is received across two terminals that provide a differential voltage (e.g. across the two lines from load device 405 to control loop 402), and the difference between the two terminals provides the magnitude of the voltage feedback V_{FB} (e.g., one terminal has the positive or higher voltage and the other terminal has the negative or lower voltage). In some examples, the voltage feedback V_{FB} is received on a single terminal. In some examples, one or more of power converter stages 206 includes a temperature sensor and can provide temperature data back to controller 204-2 via a corresponding temperature terminal (TMP1, . . . , TMPn).

Phase manager 404 receives the drive signal produced by control loop 402 and uses at least the drive signal to determine the state of the PWM_{N} signals, which in turn drive the operation of up to N different power converter stages 206. It should be noted that, in some applications, only a subset of the total number of power converter stages 206 are activated to deliver the demanded load current.

Output current is produced by each of the activated power converter stages 206 and is passed through any number of inductors 406 to produce a smoother DC current output that is summed across all of the activated power converter stages 206. The total output current is delivered across a power delivery network 408 to reach load device 405 as I_{OUT} with the output potential V_{OUT} across any number of coupling capacitors 410. Coupling capacitors 410 may be connected between a first terminal having a potential of V_{OUT} and a second terminal having a grounded potential (or a lower potential compared to V_{OUT}). A board interface 412 may be used to facilitate the transfer of the signals from power delivery network 408 to load device 405. Board interface 412 may represent any connection interface between power delivery network 408 and load device 405, such as a socket or solder interface. Power delivery network 408 may represent any conductive pathways across which current can travel, such as metallic traces on a PCB. Coupling capacitors 410 may be designed in ways to reduce the transient switching response time by providing faster switching times between the different power converter stages 206.

### Delay Control Circuit Architecture

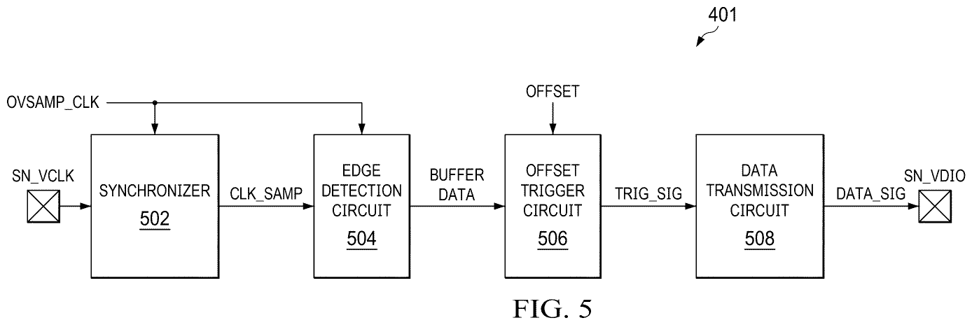

FIG. 5 illustrates a block diagram of various components of delay control circuit 401, according to an example. Delay control circuit 401 may include a synchronizer 502, an edge detection circuit 504, an offset trigger circuit 506, and a data transmission circuit 508. Each of the components of delay control circuit 401 can include any number of analog or digital circuitry to carry out particular operations as described herein. In some examples, each of the components of delay control circuit 401 are integrated onto a single chip or may be split amongst more than one chip in a system-in-package (SIP) arrangement. Other examples may be configured differently.

According to some examples, a first clock signal (e.g., the primary clock signal) is received at the SN_VCLK terminal of the controller by synchronizer 502, which includes one or more components used to convert the potentially noisy clock signal into a smooth square wave signal by sampling the first clock signal with a higher-frequency second clock signal (e.g., an oversampled clock signal OVSAMP_CLK). In some examples, OVSAMP_CLK is generated by a phase locked loop (PLL) within delay control circuit 401 or generally within secondary controller 204.

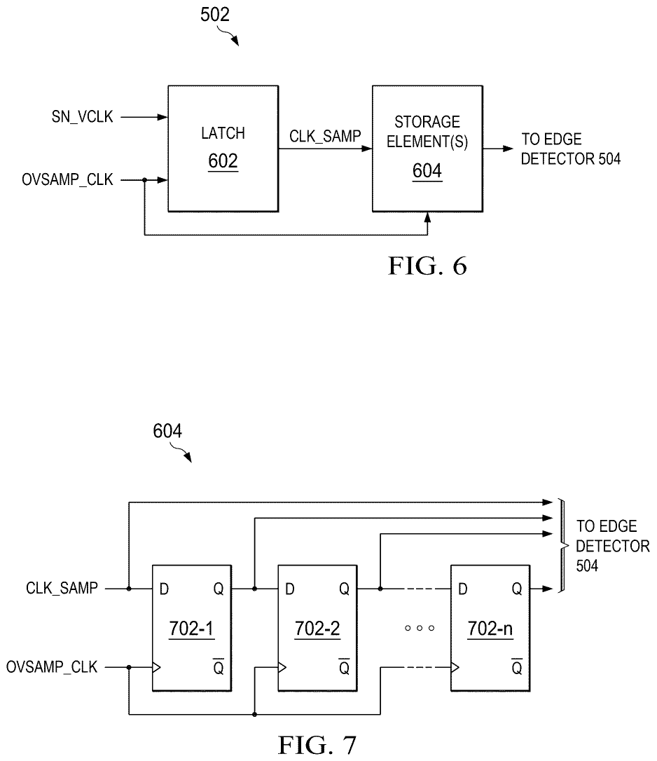

FIG. 6 illustrates a more detailed diagram of synchronizer 502, according to some examples. Other examples may be configured differently. In some examples, synchronizer 502 is a strong-arm based synchronizer that includes at least one latch 602 or other similar digital storage element to convert the first clock signal (SN_VCLK) into a sampled version of the first clock signal (Clk_samp). In some examples, first clock signal SN_VCLK may have a frequency between about 5 MHz and 50 MHz, while the second clock signal (OVSAMP_CLK) has a higher frequency between about 750 MHz and 850 MHz, and is used to sample first clock signal SN_VCLK to convert the signal into a smoother square wave signal represented by a third clock signal (Clk_samp).

According to some examples, Clk_samp is received by one or more storage elements 604 before being passed on to edge detector circuit 504. As seen in FIG. 7, storage element(s) 604 may be a cascaded chain of flip-flops 702-1-702-n (collectively referred to as flip flops 702), that are each driven by the second clock signal OVSAMP_CLK. The output of each flip flop 702 may also be received by edge detector circuit 504 in order to compare any number of sequential samples to ensure that the Clk_samp rising edge (or falling edge) is a true rising edge (or falling edge) and not the product of noise or a glitch. For example, five chained flip flops 702 may be used to ensure that Clk_samp remains HIGH for at least 5 samples after a suspected rising edge of Clk_samp, or that Clk_samp remains LOW for at least 5 samples after a suspected falling edge of Clk_samp. FIG. 7 illustrates one example of storage element(s) 604. Other examples may be configured differently.

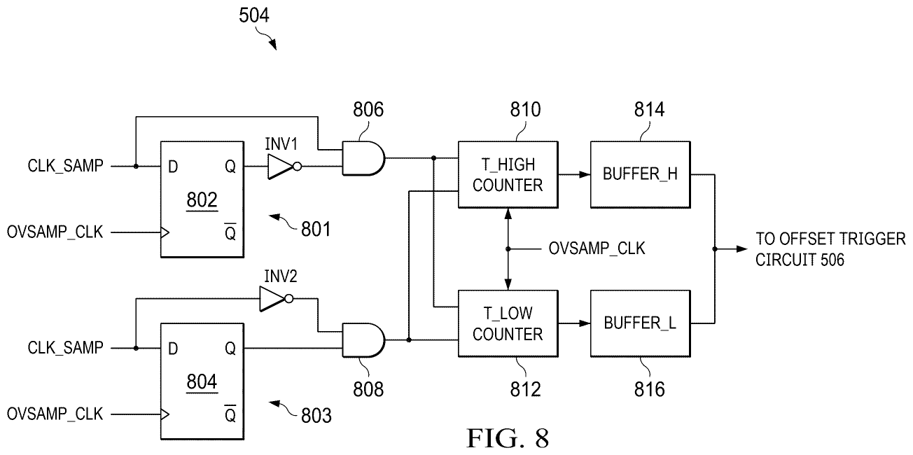

Returning to FIG. 5, the third clock signal Clk_samp, including any sequential samples obtained using flip flops 702, is received by edge detection circuit 504, where rising and falling edges of Clk_samp are identified. FIG. 8 illustrates edge detection circuit 504, according to some examples. Other examples may be configured differently. Edge detection circuit 504 includes a rising edge detector 801 and a falling edge detector 803. Rising edge detector 801 includes at least one flip-flop 802 driven by second clock signal OVSAMP_CLK and having an input (D) that receives Clk_samp. Similarly, falling edge detector 803 includes at least one flip-flop 804 driven by second clock signal OVSAMP_CLK and having an input (D) that receives Clk_samp. An AND gate 806 receives third clock signal Clk_samp and the inverted output of flip-flop 802 (e.g., through inverter INV1) in rising edge detector 801, and another AND gate 808 receives the inverted form of third clock signal Clk_samp (e.g., through inverter INV2) and the output of flip-flop 804 in falling edge detector 803. It should be understood that AND gates 806 and 808 may also each receive any number of other clock samples corresponding to the outputs of flip flops 702 from synchronizer 502.

According to some examples, a rising edge of Clk_samp will cause AND gate 806 to temporarily output a logic HIGH (e.g., until flip-flop 802 is reset by OVSAMP_CLK). The output HIGH pulse from AND gate 806 may be received by each of T-HIGH counter 810 and T_LOW counter 812, which may each represent digital counters. According to some examples, T_HIGH counter 810 begins counting when receiving a HIGH output from AND gate 806, and T_LOW counter 812 stops counting and is reset upon receiving the HIGH output from AND gate 806. In some examples, T_HIGH counter 810 is driven by OVSAMP_CLK to count a number of cycles of OVSAMP_CLK before it is reset (e.g., upon falling edge detector 803 receiving a falling edge of Clk_samp). Data corresponding to the number of counted cycles of OVSAMP_CLK by T_HIGH counter 810 may be stored in a first buffer (BUFFER_H) 814. In a similar fashion, a falling edge of Clk_samp will cause AND gate 808 to temporarily output a logic HIGH (e.g., until flip-flop 804 is reset by OVSAMP_CLK). The output HIGH pulse from AND gate 808 may be received by each of T-HIGH counter 810 and T_LOW counter 812. According to some examples, T_LOW counter 812 begins counting when receiving a HIGH output from AND gate 808, and T_HIGH counter stops counting and is reset upon receiving the HIGH output from AND gate 808. In some examples, T_LOW counter 812 is driven by OVSAMP_CLK to count a number of cycles of OVSAMP_CLK before it is reset (e.g., upon rising edge detector 801 receiving a rising edge of Clk_samp). Data corresponding to the number of counted cycles of OVSAMP_CLK by T_LOW counter 812 may be stored in a second buffer (BUFFER_L) 816. The saved data within first buffer 814 corresponds to the time duration between a rising edge and a falling edge of Clk_samp, and the saved data within second buffer 816 corresponds to the time duration between a falling edge and a rising edge of Clk_samp. As described above, the third clock signal Clk_samp represents a sampled form of the first clock signal (e.g., the primary clock signal).

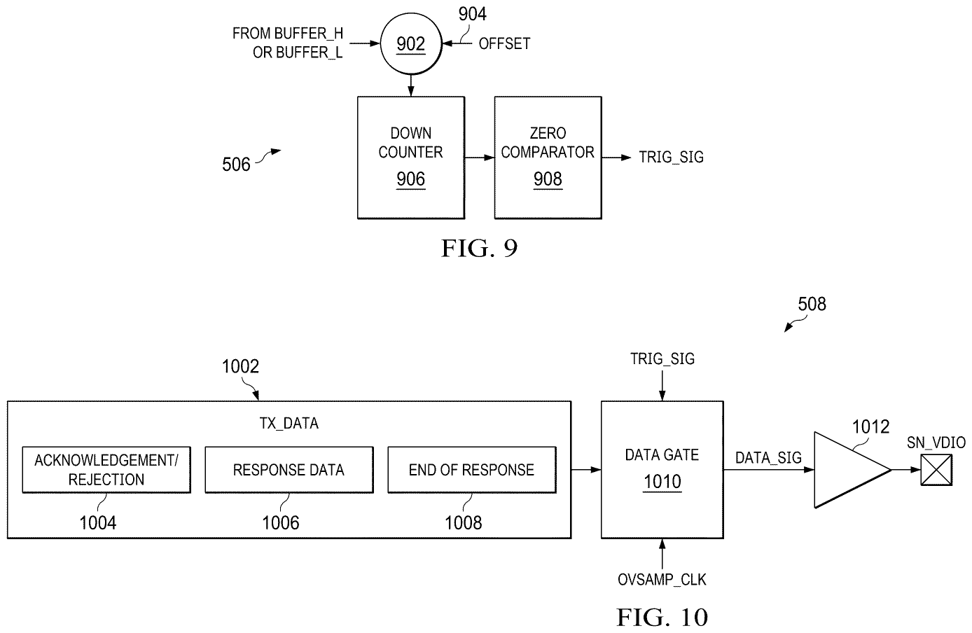

Returning to FIG. 5, the data stored in either first buffer 814 or second buffer 816 is used by offset trigger circuit 506, along with an offset input, to generate a trigger signal to send any data back to the primary controller, according to some examples. According to some examples, the offset may be stored in a buffer as part of delay control circuit 401 or in any other suitable location and represents a product between an offset parameter and a period of the second clock signal OVSAMP_CLK. FIG. 9 illustrates offset trigger circuit 506, according to some examples. Other examples may be configured differently. The time duration data within first buffer 814 or second buffer 816 may be reduced at a subtraction circuit 902 by an offset 904. The offset parameter may be a predetermined positive integer corresponding to a number of cycles of the second clock signal OVSAMP_CLK that should be reduced from the stored number of cycles of the second clock signal in either first buffer 814 or second buffer 816. For example, OVSAMP_CLK may have a period of 1.25 ns (e.g., corresponding to an 800 MHz clock) and the offset parameter may be selected by a user (or automatically determined) to be 3, which would generate an offset of 1.25 ns ×3=3.75 ns. In some examples, offset 904 is different for each secondary controller and may be related to the distance between the secondary controller and the primary controller (e.g., offset 904 is greater the further the secondary controller is from the primary controller). According to some examples, the offset parameter is a user-configurable parameter to adjust the timing in which data is sent from a given secondary controller back to the primary controller.

According to some examples, a countdown of the reduced time duration is performed by down counter 906, which may be implemented using any suitable digital counter (e.g., implemented as a finite state machine having any number of flip-flop circuits driven by OVSAMP_CLK). A zero comparator 908 may be used to determine when the output of down counter 906 reaches zero, and to assert a trigger signal (TRIG_SIG) when the count reaches zero.

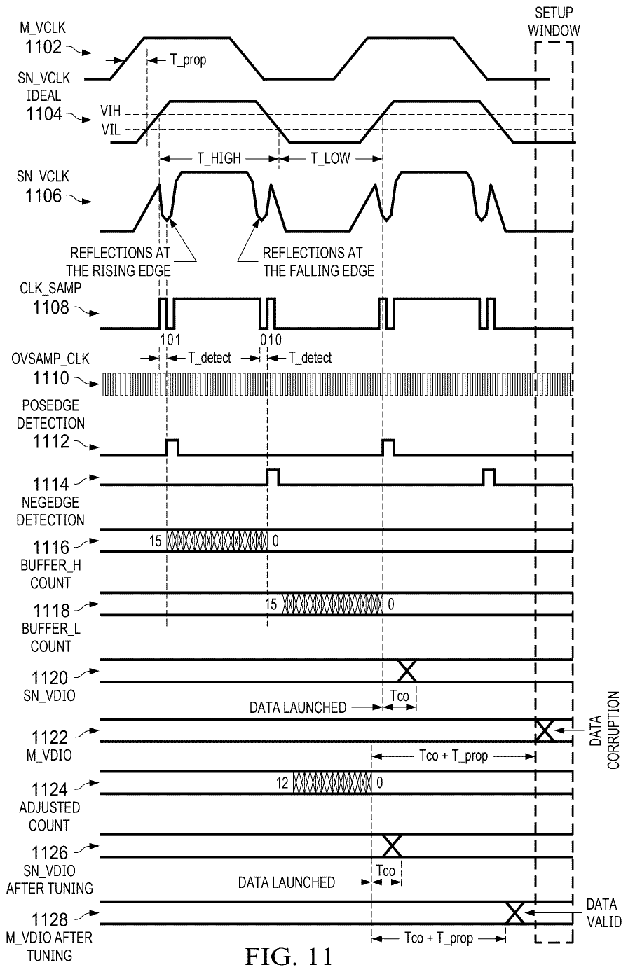

Returning to FIG. 5, the trigger signal generated by offset trigger circuit 506 may be received by data transmission circuit 508 to cause data to be transmitted back to the primary controller via the SN_VDIO terminal, according to some examples. FIG. 10 illustrates data transmission circuit 508, according to some examples. Other examples may be configured differently. Data transmission circuit 508 may include a data buffer 1002 that includes any number of stored data bits. In some examples, the stored data bits include a first portion of bits 1004 corresponding to an acknowledgement or rejection of instructions received from the primary controller, a second portion of bits 1006 corresponding to response data, which may include diagnostic information regarding the secondary controller, and a third portion of bits 1008 to signify an end of the response data. In some examples, the bits of each of first portion of bits 1004, second portion of bits 1006, and third portion of bits 1008 may be transmitted together as a single bit stream. The bit data may be generated by secondary controller 204 or may correspond to data received by secondary controller 204 (e.g., diagnostic data received from any of power converter stages 206).

The stored data within data buffer 1002 may be received at an input of a data gate 1010, which outputs the data upon the assertion of the trigger signal TRIG_SIG, according to some examples. Data gate 1010 may include any number of flip-flops or other digital storage elements, and/or any number of switches, such as field-effect transistor (FET) switches. Any data storage elements of data gate 1010 may be driven by the second clock signal OVSAMP_CLK. Upon receipt of the trigger signal TRIG_SIG, data gate 1010 outputs the data stored in data buffer through the SN_VDIO terminal as the data signal DATA_SIG to return to the primary controller. In some examples, the data is first received by a buffer 1012 before being sent through the SN_VDIO terminal to help boost the signal and/or to isolate the impedance between data gate 1010 and anything the SN_VDIO terminal is connected to.

FIG. 11 provides an example timing diagram of various signals used by delay control circuit 401 to affect the timing of data transmission between a secondary controller and a primary controller, according to some examples. Signal 1102 represents a primary clock signal as it may appear at the clock output terminal of primary controller 202 (M_VCLK). Signal 1104 represents an ideal representation of the primary clock signal as it is received by the clock input of a given secondary controller 204 (SN_VCLK). Note that a delay (T_prop) exists between sending the primary clock signal from the primary controller and receiving the primary clock signal at the secondary controller. The length of T_prop is related to the length of the conductive trace between the primary controller and the secondary controller. Signal 1106 represents a noisy representation of the primary clock signal at the clock input of secondary controller 204 (SN_VCLK). The noise in the clock signal may be caused by reflections on the signal line or any other parasitic effects. Due to the noisy clock signal, the true rising and falling edges of the clock signal are more challenging to identify.

According to some examples, signal 1108 represents a sampled version Clk_samp of the primary clock signal (e.g., at the output of synchronizer 502). The sampled clock signal Clk_samp removes the noise to create a stable square wave representation of the primary clock signal. According to some examples, signal 1110 represents a second clock signal (OVSAMP_CLK) that is used to sample the primary clock signal at SN_VCLK in order to generate the sampled clock signal Clk_samp. Due to the higher frequency of the second clock signal OVSAMP_CLK, the reflections in the primary clock signal remain visible in the sampled clock signal Clk_samp as premature falling and rising edges.

Signal 1112 represents the output of rising edge detector 801 (e.g., the output of AND gate 806) used to identify the rising edges of the sampled clock signal Clk_samp, according to some examples. In this example, a rising edge is detected if at least a predetermined number of sequential samples from Clk_samp are at a logic HIGH. Accordingly, signal 1112 includes pulses at the identified rising edges of Clk_samp. Similarly, signal 1114 represents the output of falling edge detector 803 (e.g., the output of AND gate 808) used to identify the falling edges of the sampled clock signal Clk_samp, according to some examples. In this example, a falling edge is detected if at least a predetermined number of sequential samples from Clk_samp are at a logic LOW. Accordingly, signal 1114 includes pulses at the identified falling edges of Clk_samp. According to some examples, signal 1116 represents the count data stored within BUFFER_H 814, which in this example includes 15 cycles of OVSAMP_CLK counted between a rising edge of Clk_samp and a subsequent falling edge of Clk_samp. Similarly, signal 1118 represents the count data stored within BUFFER_L 816, which in this example also includes 15 cycles of OVSAMP_CLK counted between a falling edge of Clk_samp and a subsequent rising edge of Clk_samp.

Signals 1120 and 1122 demonstrate what happens when the timing of transmitting the data is not adjusted. As shown in signal 1120, the data signal is launched from the SN_VDIO terminal of secondary controller 204 upon receiving a rising edge of the primary clock signal. The ‘X’ identifies the time at which the data signal is actually transmitted following some internal delay Tco. Signal 1122 shows the data signal being received at the M_VDIO terminal of primary controller 202 following a propagation time (T_prop) along a conductive trace between the primary and secondary controllers. The data signal is received during the “setup window” prior to a rising edge of the primary clock, which can lead to protocol timing errors and/or data corruption as described above.

Signals 1124, 1126, and 1128 demonstrate what happens when the timing of transmitting the data signal is adjusted to account for the propagation delay, according to some examples. Signal 1124 represents an adjusted count from the count stored in BUFFER_L 816. In the illustrated example, the count data from BUFFER_L 816 is reduced by an offset to yield a new count of 12 instead of 15. Rather than waiting to transmit the data signal on the rising edge of the primary clock, the data signal is instead launched following a countdown of the adjusted count, according to some examples. Once the countdown reaches zero, the data launch commences as identified by signal 1126. The ‘X’ identifies the time at which the data signal is actually transmitted following some internal delay Tco. Signal 1128 shows the data signal being received at the M_VDIO terminal of primary controller 202 following a propagation time (T_prop) along a conductive trace between the primary and secondary controllers. Since the data signal was transmitted early to account for the propagation delay, the data signal is received before the “setup window”, which allows for successful receipt of the data at primary controller 202.

### Methodology

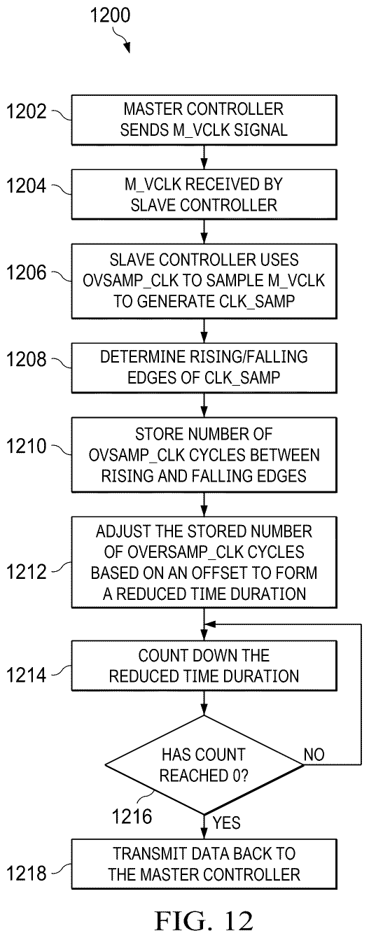

FIG. 12 illustrates a flow chart of a method 1200 for adjusting the timing of data transmission between secondary controllers and a primary controller to account for differences in conductive trace lengths between the secondary controllers and the primary controller, in an example. The methodology can be carried out, for example, by any of controllers 204 shown in FIG. 2 having the delay control circuit 401 of FIG. 5.

Method 1200 begins with operation 1202 where the primary controller transmits a primary clock signal M_CLK (e.g., a first clock signal). The primary clock signal may be sent to any number of secondary controllers at the same time as illustrated, for example, at FIG. 2. In some examples, M_CLK has a frequency between about 5 MHz and 50 MHz.

Method 1200 continues with operation 1204 where M_VCLK is received by a given secondary controller. In an example, the primary clock signal is received at a clock input terminal S_VCLK. This received signal may include noise or other non-linear effects.

Method 1200 continues with operation 1206 where the secondary controller uses a second clock signal OVSAMP_CLK with a higher frequency than M_CLK in order to oversample M_CLK and generate a third clock signal CLK_SAMP. According to some examples, the third clock signal CLK_SAMP represents the oversampled version of M_CLK. According to some examples, CLK_SAMP provides a more traditional square wave representation of the primary clock signal. In some examples, additional filtering or averaging may be performed on CLK_SAMP to smooth out any jitter due to noise or other non-liner effects. In some examples, OVSAMP_CLK has a frequency between 750 MHz and 850 MHz. According to some examples, operation 1206 may be performed by synchronizer 502.

Method 1200 continues with operation 1208 where rising and falling edges of CLK_SAMP are determined. According to some examples, a rising edge detector (such as rising edge detector 801) is used to determine the moment when CLK_SAMP changes from a logic LOW to a logic HIGH. In some examples, more than one sequential sample of CLK_SAMP is compared to ensure that the rising edge is a true rising edge and not the result of noise or transmission line reflections. According to some examples, a falling edge detector (such as falling edge detector 803) is used to determine the moment when CLK_SAMP changes from a logic HIGH to a logic LOW. In some examples, more than one sequential sample of CLK_SAMP is compared to ensure that the falling edge is a true falling edge and not the result of noise or transmission line reflections.

Method 1200 continues with operation 1210 where a number of clock cycles from OVSAMP_CLK are counted between rising and falling edges of CLK_SAMP and stored in respective buffers. According to some examples, a first number of clock cycles from OVSAMP_CLK between a rising edge and a subsequent falling edge of CLK_SAMP is stored in a first buffer, and a second number of clock cycles from OVSAMP_CLK between a falling edge and a subsequent rising edge of CLK_SAMP is stored in a second buffer. In many situations, the first number of clock cycles equals the second number of clock cycles, but board noise or other parasitic effects could make these values different. According to some examples, operations 1208 and 1210 are performed by edge detection circuit 504.

Method 1200 continues with operation 1212 where the second number of clock cycles stored in the second buffer is adjusted (e.g., decreased) based on an offset to generate a reduced time duration. According to some examples, the offset may be a positive integer corresponding to a number of cycles of OVSAMP_CLK that should be reduced from the stored second number of clock cycles. In some examples, the offset represents a product between the forementioned positive integer and a period of OVSAMP_CLK. In some examples, the offset is different for each secondary controller and may be related to the distance between the secondary controller and the primary controller. According to some examples, the offset is a user-configurable parameter to adjust the timing in which data is sent from the secondary controller back to the primary controller. According to some examples, operation 1212 is performed by offset trigger circuit 506.

Method 1200 continues with operation 1214, where a down counter may be used to count down the number of cycles of OVSAMP_CLK within the reduced time duration. According to some examples, a decision is made at operation 1216 based on whether the down count has reached zero. If the count has not yet reached zero, method 1200 returns to operation 1214 to continue counting down. If the count has reached zero, method 1200 continues to operation 1218 where a data signal is transmitted back to the primary controller. In some examples, a trigger signal is generated upon the down count reaching zero, with the trigger signal causing a data gate to pass the data signal onto a secondary data terminal S_VDIO. The data signal is then transmitted across a data line trace from the secondary controller to the primary controller. According to some examples, operation 1214 is performed by both edge detection circuit 504 and data transmission circuit 508.

### Example Power Converter Circuitry

FIG. 13 illustrates an example of a given secondary controller 204 along with a more detailed schematic diagram of a single power converter stage 206. In some cases, power converter stage 206 represents any of power converter stages 206 illustrated in FIG. 2. Accordingly, it should be understood that for a multiphase architecture, the output signals from controller 204 to power converter stage 206 would be repeated to each of power converter stages 206-1 through 206-n. The inductor LOUT may be considered part of power converter stage 206, or may be considered a separate element coupled to the output of power converter stage 206.

According to some examples, power converter stage 206 includes a circuit with various input/output (I/O) terminals, such as a power input terminal (PVIN), a bootstrap terminal (BST), a switching node terminal (SW), and a ground terminal (GND). Any number of other I/O terminals may be provided.

According to some examples, power converter stage 206 includes a high-side switching element (HS) along with an associated high-side driver (HSD) and a low-side switching element (LS) along with an associated low-side driver (LSD). As shown in FIG. 13, both high-side switching element HS and low-side switching element LS may be n-channel MOSFETs, although other suitable switching elements may be used. High-side switching element HS has a first terminal coupled to an input power rail (e.g., PVIN terminal) and a second terminal coupled to the switching node SW of the power converter. Accordingly, the state of high-side driver HSD controls the gate terminal of high-side switching element HS, and high-side switching element HS provides the input voltage on PVIN to switching node SW when the high-side switching element HS is on. Low-side switching element LS has a first terminal coupled to the switching node SW and a second terminal coupled to a ground rail (e.g., at ground terminal GND). The ground terminal GND may be a global ground associated with the chip that includes power converter stage 206. The state of low-side driver LSD controls the gate terminal of low-side switching element LS, and low-side switching element LS provides a ground voltage to switching node SW when the low-side switching element LS is on. Only one of HS and LS can be on at any given time and LS is off whenever HS is on and vice versa.

A boost capacitor Cb may be coupled between the switching node SW and bootstrap terminal BST (or a bootstrap voltage rail) and can be used to provide a boosted voltage that is higher than the output switching voltage at SW in conjunction with a bootstrap charging circuit 1302 (e.g., used to charge Cb) between bootstrap terminal BST and input voltage terminal PVIN. This boosted voltage may then be provided to the positive supply rail of the high-side driver HS.

An inductor LOUT may be provided at the switching node SW to smooth out the changing voltage and provide a more stable DC output voltage as VOUT. In some cases, inductor LOUT may be, for example, part of a transformer, or any other suitable energy storage element. A voltage divider that includes resistors R1 and R2 may be provided at the output (e.g. at or near the load) to generate a feedback voltage that is fed to feedback terminal FB of secondary controller 204. It should be noted that, in some examples, the feedback voltage FB is not provided by each power converter stage 206 of a multiphase system, but rather at the load output (e.g., the output of the power converter system).

As described above, secondary controller 204 provides the control signals (e.g., HS_{PWM} and LS_{PWM}) to the inputs of high-side driver HSD and low-side driver LSD, respectively. According to some examples, HS_{PWM} represents the PWM signal output by the drive stage associated with power converter stage 206 to drive the respective high-side switching element HS. The LS_{PWM} signal may be the inverse of HS_{PWM}, according to some examples.

According to some examples, controller 204 also receives current feedback I_{FB} from each power converter stage 206 via a current sensing block 1304. In some examples, current sensing block 1304 includes an arrangement of any number of resistors and/or operational amplifiers to sense the current amplitude at the switching terminal SW.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal,” “node,” “interconnection,” “pin,” and “lead” are used interchangeably. Unless specifically stated to the contrary, these terms are generally used to mean an interconnection between or a terminus of a device element, a circuit element, an integrated circuit, a device, or a semiconductor component. Furthermore, a voltage rail or more simply a “rail,” may also be referred to as a voltage terminal and may generally mean a common node or set of coupled nodes in a circuit at the same potential.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, such as by an end user and/or a third party.

While the use of particular transistors is described herein, other transistors (or equivalent devices) may be used instead. For example, a p-channel field effect transistor (PFET) may be used in place of an n-channel field effect transistor (NFET) with little or no changes to the circuit. Furthermore, other types of transistors may be used (such as bipolar junction transistors (BJTs)). Furthermore, the devices may be implemented in/over a silicon substrate (Si), a silicon carbide substrate (SiC), a gallium nitride substrate (GaN) or a gallium arsenide substrate (GaAs). Moreover, reference to transistor features such as gate, source, or drain is not intended to exclude any suitable transistor technologies. For instance, features such as source, drain, and gate are typically used to refer to a FET, while emitter, collector, and base are typically used to refer to a BJT. Such features may be used interchangeably herein. For instance, reference to the gate of a transistor may refer to either the gate of a FET or the base of a BJT, and vice-versa. In some examples, a control terminal may refer to either the gate of a FET or the base of a BJT. Any other suitable transistor technologies can be used. Any such transistors can be used as a switch, with the gate or base or other comparable feature acting as a switch select input that can be driven to connect the source and drain (or the emitter and collector, as the case may be).

References herein to a field effect transistor (FET) being “ON” (or a switch being closed) means that the conduction channel of the FET is present, and drain current may flow through the FET. References herein to a FET being “OFF” (or a switch being open) means that the conduction channel is not present, and drain current does not flow through the FET. A FET that is OFF, however, may have current flowing through the transistor's body-diode.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter.

### Further Examples

Example 1 is an electronic device that includes a synchronizer configured to receive a first clock signal and to generate a second clock signal responsive to the first clock signal and a third clock signal, an edge detection circuit configured to determine a rising edge of the second clock signal and a falling edge of the second clock signal, an offset trigger circuit, and a data transmission circuit. The edge detection circuit also stores a first time duration between the rising edge and the falling edge based on a number of pulses from the third clock signal between the rising edge and the falling edge. The offset trigger circuit is designed to subtract an offset from the first time duration to yield a second time duration smaller than the first time duration, count a number of pulses from the third clock signal within the second time duration, and in response to reaching an end of the count, output a trigger signal. The data transmission circuit receives the trigger signal and outputs a data signal in response to receiving the trigger signal.

Example 2 includes the electronic device of Example 1, wherein a frequency of the third clock signal is between 750 MHz and 850 MHz.

Example 3 includes the electronic device of Example 1 or 2, wherein the synchronizer comprises one or more flip-flop circuits.

Example 4 includes the electronic device of any one of Examples 1-3, wherein the falling edge is a first falling edge of the second clock signal, the edge detection circuit being further configured to: determine a second falling edge of the second clock signal, such that the rising edge is between the first falling edge and the second falling edge; and store a third time duration between the rising edge and the second falling edge based on a number of pulses from the third clock signal between the rising edge and the second falling edge.

Example 5 includes the electronic device of Example 4, wherein the first time duration is stored within a first buffer and the third time duration is stored within a second buffer.

Example 6 includes the electronic device of any one of Examples 1-5, wherein the offset trigger circuit is configured to count down from a total number of pulses from the third clock signal within the second time duration and is configured to output the trigger signal when the count reaches zero.

Example 7 includes the electronic device of any one of Examples 1-6, wherein the offset represents a product between an offset parameter and a period of the third clock signal.

Example 8 includes the electronic device of Example 7, wherein the offset parameter is a user-configurable parameter.

Example 9 includes the electronic device of Example 7 or 8, wherein the offset parameter is a positive integer.

Example 10 includes the electronic device of any one of Examples 1-9, further comprising a data buffer configured to store data, wherein the data signal includes the data from the data buffer.

Example 11 is a system that includes a first controller designed to generate a first clock signal, a plurality of second controllers each designed to receive the first clock signal from the first controller and to transmit a data signal to the first controller, and a plurality of power converter stages. Each of the power converter stages corresponds to a second controller of the plurality of second controllers and is configured to receive a pulse width modulated (PWM) signal from the corresponding second controller. At least one of the second controllers includes a synchronizer designed to receive the first clock signal and to generate a second clock signal responsive to the first clock signal and a third clock signal, an edge detection circuit designed to use the third clock signal to determine a rising edge of the second clock signal and a falling edge of the second clock signal, an offset trigger circuit, and a data transmission circuit. The edge detection circuit also stores a first time duration between the rising edge and the falling edge of the second clock signal. The offset trigger circuit is designed to reduce the first time duration based on an offset to yield a second time duration, count a number of pulses from the third clock signal within the second time duration, and in response to reaching an end of the count, output a trigger signal. The data transmission circuit receives the trigger signal and transmits the data signal in response to receiving the trigger signal.

Example 12 includes the system of Example 11, further comprising a first conductive trace between a given controller of the plurality of second controllers and the first controller, and a second conductive trace between another controller of the plurality of second controllers and the first controller, wherein the first conductive trace has a first length that is different than a second length of the second conductive trace.

Example 13 includes the system of Example 11 or 12, wherein a frequency of the third clock signal is between 750 MHz and 850 MHz.

Example 14 includes the system of any one of Examples 11-13, wherein the synchronizer comprises one or more flip-flop circuits.

Example 15 includes the system of any one of Examples 11-14, wherein the falling edge is a first falling edge of the second clock signal, and the edge detection circuit is further configured to: determine a second falling edge of the second clock signal, such that the rising edge is between the first falling edge and the second falling edge; and store a third time duration between the rising edge and the second falling edge based on a number of pulses from the third clock signal between the rising edge and the second falling edge.

Example 16 includes the system of Example 15, wherein the first time duration is stored within a first buffer and the third time duration is stored within a second buffer.

Example 17 includes the system of any one of Examples 11-16, wherein the offset trigger is configured to count down from a total number of pulses from the third clock signal within the second time duration and is configured to output the trigger signal when the count reaches zero.

Example 18 includes the system of any one of Examples 11-17, wherein the offset represents a product between an offset parameter and a period of the third clock signal.

Example 19 includes the system of Example 18, wherein the offset parameter is a user-configurable parameter.

Example 20 includes the system of Example 18 or 19, wherein the offset parameter is a positive integer.

Example 21 includes the system of any one of Examples 11-20, wherein the at least one of the second controllers further comprises a data buffer configured to store data, and wherein the data signal comprises the data stored in the data buffer.

Example 22 is a system that includes a processor, a first controller configured to generate a clock signal, a second controller configured to receive the clock signal from the first controller and to transmit a first data signal to the first controller through a first conductive trace having a first trace length, a third controller configured to receive the clock signal from the first controller and to transmit a second data signal to the first controller through a second conductive trace having a second trace length different from the first trace length, a first plurality of power stages coupled to the second controller and designed to provide a first output voltage to at least a portion of the processor, and a second plurality of power stages coupled to the third controller and designed to provide a second output voltage to at least a portion of the processor. The second controller transmits the first data signal at a first time corresponding to a first offset from a first time duration associated with a time between a first rising edge and a first falling edge of the clock signal. The third controller transmits the second data signal at a second time corresponding to a second offset from a second time duration associated with a time between a second rising edge and a second falling edge of the clock signal with the second offset being different from the first offset.

Example 23 includes the system of Example 22, wherein the clock signal is a first clock signal, the first time duration includes a first number of pulses from a second clock signal having a higher frequency than the first clock signal, and the second time duration includes a second number of pulses from the second clock signal.

Example 24 includes the system of Example 23, wherein a frequency of the second clock signal is between 750 MHz and 850 MHz.

Example 25 includes the system of Example 23 or 24, wherein the first number of pulses from the second clock signal is equal to the second number of pulses from the second clock signal.

Example 26 includes the system of any one of Examples 23-25, wherein the first offset represents a product between a first offset parameter and a period of the second clock signal, and the second offset represents a product between a second offset parameter and the period of the second clock signal.

Example 27 includes the system of Example 26, wherein each of the first and second offset parameters is a user-configurable parameter.

Example 28 includes the system of Example 26 or 27, wherein each of the first and second offset parameters is a positive integer.

Example 29 includes the system of any one of Examples 22-28, wherein the first time duration is stored within a first buffer of the second controller and the second time duration is stored within a second buffer of the third controller.

Example 30 includes the system of any one of Examples 22-29, wherein the second controller comprises a first data buffer configured to store first data, and wherein the first data signal comprises the first data stored in the first data buffer, and wherein the third controller comprises a second data buffer configured to store second data, and wherein the second data signal comprises the second data stored in the second data buffer.

Example 31 includes the system of any one of Examples 22-30, wherein the first plurality of power stages are configured to provide the first voltage to a first portion of the processor, and the second plurality of power stages are configured to provide the second voltage to a second portion of the processor different from the first portion.

Modifications are possible in the described examples, and other examples are possible within the scope of the claims.

What is claimed is:

1. An electronic device comprising:
a synchronizer configured to receive a first clock signal to generate a second clock signal responsive to the first clock signal and a third clock signal;
an edge detection circuit configured to determine a rising edge of the second clock signal and a falling edge of the second clock signal, and to store a first time duration between the rising edge and the falling edge responsive to a number of pulses from the third clock signal between the rising edge and the falling edge;
an offset trigger circuit configured to
subtract an offset from the first time duration to yield a second time duration smaller than the first time duration,
count a number of pulses from the third clock signal within the second time duration, and
in response to reaching an end of the count, output a trigger signal; and
a data transmission circuit configured to receive the trigger signal and to output a data signal in response to receiving the trigger signal.

2. The electronic device of claim 1, wherein the synchronizer comprises one or more flip-flop circuits.

3. The electronic device of claim 1, wherein the falling edge is a first falling edge of the second clock signal, the edge detection circuit being further configured to:
determine a second falling edge of the second clock signal, such that the rising edge is between the first falling edge and the second falling edge; and
store a third time duration between the rising edge and the second falling edge responsive to a number of pulses from the third clock signal between the rising edge and the second falling edge.

4. The electronic device of claim 1, wherein the offset trigger circuit is configured to count down from a total number of pulses from the third clock signal within the second time duration and is configured to output the trigger signal when the count reaches zero.

5. The electronic device of claim 1, wherein the offset represents a product between an offset parameter and a period of the third clock signal.

6. The electronic device of claim 1, further comprising a data buffer configured to store data, wherein the data signal includes the data from the data buffer.

7. A system comprising:
a first controller configured to generate a first clock signal;
a plurality of second controllers each configured to receive the first clock signal from the first controller and to transmit a data signal to the first controller; and
a plurality of power converter stages, each power converter stage corresponding to a second controller of the plurality of second controllers and configured to receive a pulse width modulated (PWM) signal from the corresponding second controller,
wherein at least one of the second controllers comprises
a synchronizer configured to receive the first clock signal and to generate a second clock signal responsive to the first clock signal and a third clock signal;
an edge detection circuit configured to use the third clock signal to determine a rising edge of the second clock signal and a falling edge of the second clock signal, and to store a first time duration between the rising edge and the falling edge;
an offset trigger circuit configured to
reduce the first time duration based on an offset to yield a second time duration,
count a number of pulses from the third clock signal within the second time duration, and
in response to reaching an end of the count, output a trigger signal; and
a data transmission circuit configured to receive the trigger signal and to transmit the data signal in response to receiving the trigger signal.

8. The system of claim 7, further comprising a first conductive trace between a given controller of the plurality of second controllers and the first controller, and a second conductive trace between another controller of the plurality of second controllers and the first controller, wherein the first conductive trace has a first length that is different than a second length of the second conductive trace.

9. The system of claim 7, wherein the synchronizer comprises one or more flip-flop circuits.

10. The system of claim 7, wherein the falling edge is a first falling edge of the second clock signal, and the edge detection circuit is further configured to:
determine a second falling edge of the second clock signal, such that the rising edge is between the first falling edge and the second falling edge; and
store a third time duration between the rising edge and the second falling edge based on a number of pulses from the third clock signal between the rising edge and the second falling edge.

11. The system of claim 10, wherein the first time duration is stored within a first buffer and the third time duration is stored within a second buffer.

12. The system of claim 7, wherein the offset trigger circuit is configured to count down from a total number of pulses from the third clock signal within the second time duration and is configured to output the trigger signal when the count reaches zero.

13. The system of claim 7, wherein the at least one of the second controllers further comprises a data buffer configured to store data, and wherein the data signal comprises the data stored in the data buffer.

14. A system comprising:
a processor;
a first controller configured to generate a clock signal;
a second controller configured to receive the clock signal from the first controller and to transmit a first data signal to the first controller through a first conductive trace having a first trace length;
a third controller configured to receive the clock signal from the first controller and to transmit a second data signal to the first controller through a second conductive trace having a second trace length different from the first trace length;
a first plurality of power stages coupled to the second controller and configured to provide a first voltage to at least a portion of the processor; and
a second plurality of power stages coupled to the third controller and configured to provide a second voltage to at least a portion of the processor;
wherein the second controller is further configured to transmit the first data signal at a first time corresponding to a first offset from a first time duration associated with a time between a first rising edge and a first falling edge of the clock signal, and
wherein the third controller is further configured to transmit the second data signal at a second time corresponding to a second offset from a second time duration associated with a time between a second rising edge and a second falling edge of the clock signal, the second offset being different from the first offset.

15. The system of claim 14, wherein the clock signal is a first clock signal, the first time duration includes a first number of pulses from a second clock signal having a higher frequency than the first clock signal, and the second time duration includes a second number of pulses from the second clock signal.

16. The system of claim 15, wherein the first number of pulses from the second clock signal is equal to the second number of pulses from the second clock signal.

17. The system of claim 15, wherein the first offset represents a product between a first offset parameter and a period of the second clock signal, and the second offset represents a product between a second offset parameter and the period of the second clock signal.

18. The system of claim 14, wherein the first time duration is stored within a first buffer of the second controller and the second time duration is stored within a second buffer of the third controller.

19. The system of claim 14, wherein the second controller comprises a first data buffer configured to store first data, and wherein the first data signal comprises the first data stored in the first data buffer, and wherein the third controller comprises a second data buffer configured to store second data, and wherein the second data signal comprises the second data stored in the second data buffer.

20. The system of claim 14, wherein the first plurality of power stages are configured to provide the first voltage to a first portion of the processor, and the second plurality of power stages are configured to provide the second voltage to a second portion of the processor different from the first portion.
